(19) United States
(12) Patent Application Publication
(10) Pub. No.: US 2018/0072501 A1
(43) Pub. Date: Mar. 15, 2018

(54) ACCELERATED CONVEYING DEVICE FOR PACK CUTTING MACHINE AND PACK CUTTING MACHINE

(71) Applicant: CVC TECHNOLOGIES INC., Taichung City (TW)

(72) Inventors: JEN-CHIEH TSAI, TAICHUNG CITY (TW); CHUNG-YUNG WU, TAICHUNG CITY (TW)

(21) Appl. No.: 15/260,736

(22) Filed: Sep. 9, 2016

(51) Int. Cl. B65G 15/00; B26D 7/06; B65G 11/02; B65B 61/06

(52) U.S. Cl. CPC B65G 15/00; B26D 7/0625; B26D 2007/0018; B65B 61/06; B65G 11/023

(57) ABSTRACT

An accelerated conveying device for a pack cutting machine, adapted to convey a severed pack efficiently, comprises a conveying portion including a conveying body and an accelerated conveying element disposed at the conveying body, wherein the accelerated conveying element is disposed at the conveying body; and a receiving portion disconnectably connected to the conveying portion and including a receiving passage body and a through hole, with the through hole penetratingly disposed at a bottom surface of the receiving passage body and corresponding in position to the accelerated conveying element so as to be penetrable by the accelerated conveying element.

### FIELD OF THE INVENTION

The present invention relates to accelerated conveying devices and, more particularly, to an accelerated conveying device for a pack cutting machine.

### BACKGROUND OF THE INVENTION

In general, a conventional pack cutting machine comprises a machine body, a conveying system, and a cutting device. The conveying system is disposed on the machine body. The cutting device is disposed on the machine body and below the conveying system.

In practice, unsevered packs, such as desiccant packs, are placed on the conveying system and conveyed thereby. Then, the unsevered packs passing through the cutting device are each severed to become single packs, and the single packs fall under gravity onto a collection table.

However, the free fall under gravity on the way to the collection table is not sufficiently efficient in conveying the severed packs.

Accordingly, it is imperative to enhance the efficiency of conveying severed packs in a pack cutting machine.

### SUMMARY OF THE INVENTION

In view of the aforesaid drawbacks of the prior art, it is an objective of the present invention to enhance the efficiency of conveying severed packs in a pack cutting machine.

In order to achieve the above and other objectives, the present invention provides an accelerated conveying device for a pack cutting machine, adapted to convey a severed pack efficiently, comprising: a conveying portion including a conveying body and an accelerated conveying element disposed at the conveying body, wherein the accelerated conveying element is disposed at the conveying body; and a receiving portion disconnectably connected to the conveying portion and including a receiving passage body and a through hole, with the through hole penetratingly disposed at a bottom surface of the receiving passage body and corresponding in position to the accelerated conveying element so as to be penetrable by the accelerated conveying element.

In an embodiment of the accelerated conveying device of the present invention, the conveying portion further comprises demountable connecting posts disposed at the conveying body.

In an embodiment of the accelerated conveying device of the present invention, the receiving portion further comprises vias which penetrate the receiving passage body and correspond in position to the demountable connecting posts, respectively.

In an embodiment of the accelerated conveying device of the present invention, the receiving passage body has a recess and a stopping element coveringly disposed at the recess.

In an embodiment of the accelerated conveying device of the present invention, the stopping element is transparent.

In an embodiment of the accelerated conveying device of the present invention, the accelerated conveying element is a conveying continuous track.

The present invention further provides a pack cutting machine, comprising: a machine body; a conveying system disposed on the machine body; a cutting device disposed on the machine body and below the conveying system; and the aforesaid accelerated conveying device disposed on the machine body and below the cutting device.

In an embodiment of the pack cutting machine of the present invention, the conveying portion further comprises demountable connecting posts disposed at the conveying body.

In an embodiment of the pack cutting machine of the present invention, the receiving portion further comprises vias which penetrate the receiving passage body and correspond in position to the demountable connecting posts, respectively.

In an embodiment of the pack cutting machine of the present invention, the receiving passage body has a recess and a stopping element coveringly disposed at the recess.

In an embodiment of the pack cutting machine of the present invention, the stopping element is transparent.

In an embodiment of the pack cutting machine of the present invention, the accelerated conveying element is a conveying continuous track.

In an embodiment of the pack cutting machine of the present invention, the accelerated conveying device is oblique to a horizontal plane of the machine body.

Therefore, the present invention provides an accelerated conveying device for a pack cutting machine and the pack cutting machine, characterized in that the conveying portion and the receiving portion together speed up the conveying of the severed packs.

### BRIEF DESCRIPTION OF THE DRAWINGS

FIG. 1 is a perspective view of an unconnected accelerated conveying device for a pack cutting machine according to an embodiment of the present invention;

FIG. 2 is a perspective view of the connected accelerated conveying device for a pack cutting machine according to an embodiment of the present invention;

FIG. 3 is a perspective view of the pack cutting machine according to an embodiment of the present invention; and

FIG. 4 is a lateral view of the pack cutting machine according to an embodiment of the present invention.

### DETAILED DESCRIPTION OF THE PREFERRED EMBODIMENTS

To enable persons skilled in the art to fully understand the objectives, features, and advantages of the present invention, the present invention is illustrated with specific embodiments, depicted by the accompanying drawings, and described hereunder.

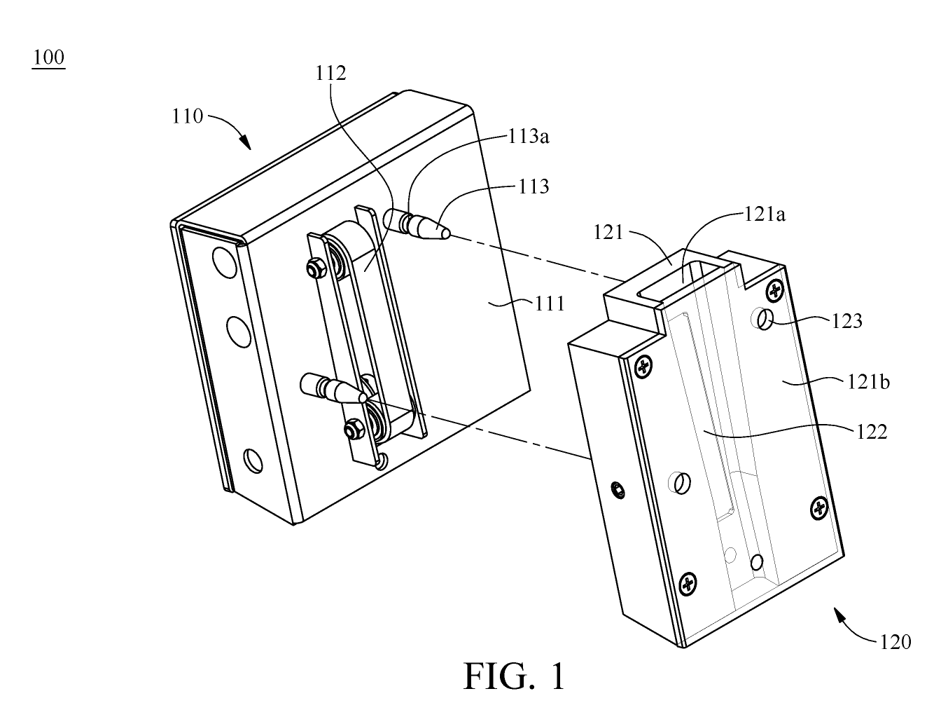

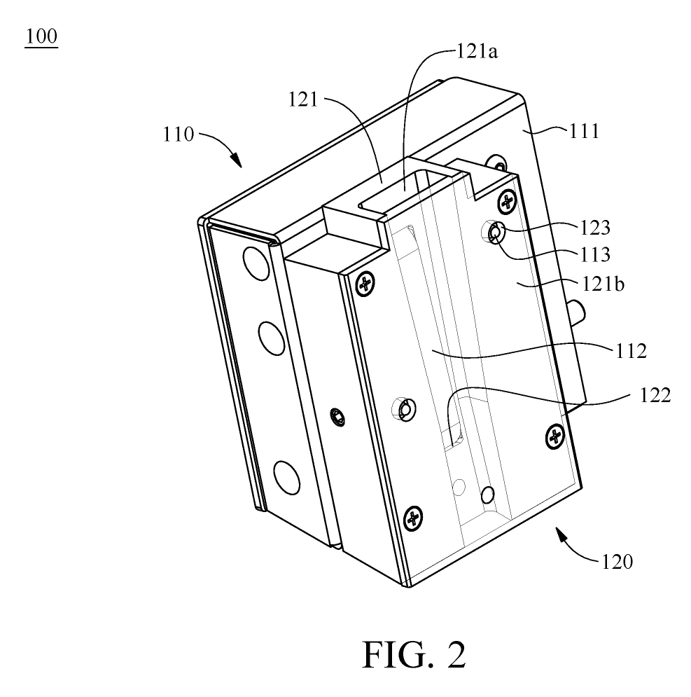

Referring to FIG. 1 and FIG. 2, there are shown perspective views of an accelerated conveying device 100 unconnected and connected to a pack cutting machine according to an embodiment of the present invention, respectively.

The accelerated conveying device 100 is disposed in the pack cutting machine (not shown) to receive a severed pack (not shown) and speed up the conveying of the severed pack.

The accelerated conveying device 100 comprises a conveying portion 110 and a receiving portion 120.

The conveying portion 110 includes a conveying body 111 and an accelerated conveying element 112. The accelerated conveying element 112 is disposed at the conveying body 111.

In this embodiment, the accelerated conveying element 112 is a conveying continuous track, but the present invention is not limited thereto; hence, all structures for use in conveying an object fall within the scope of the claims of the present invention.

The receiving portion 120 includes a receiving passage body 121 and a through hole 122. The receiving passage body 121 has a recess 121a and a stopping element 121b. The stopping element 121b is coveringly disposed at the recess 121a. The through hole 122 is penetratingly disposed at the bottom surface of the recess 121a of the receiving passage body 121. The through hole 122 corresponds in position to the accelerated conveying element 112. As soon as the receiving portion 120 is connected to the conveying portion 110, the accelerated conveying element 112 of the conveying portion 110 penetrates the through hole 122 of the receiving portion 120.

In this embodiment, the stopping element 121b is transparent such that users watch through the stopping element 121b to determine whether the severed packs which have entered the accelerated conveying device 100 are abnormal (for example, stuck), thereby allowing the users to cope with the abnormality timely.

The conveying portion 110 further comprises two demountable connecting posts 113. The demountable connecting posts 113 are disposed at the conveying body 111. An engaging neck portion 113a of a relatively small diameter is disposed centrally at each demountable connecting post 113. The receiving portion 120 further comprises two vias 123. The vias 123 penetrate the receiving passage body 121. The vias 123 correspond in position to the demountable connecting posts 113, respectively. Hence, the engaging neck portions 113a of the demountable connecting posts 113 are temporarily engaged with the vias 123, respectively. To separate the demountable connecting posts 113 from the vias 123, the users only need to exert simultaneously two outward forces on each demountable connecting post 113 and each via 123 in two opposite directions, respectively. The quantity and arrangement of the demountable connecting posts 113 and the vias 123 serves an illustrative purpose, but the present invention is not limited thereto; hence, all structures whereby the conveying portion 110 and the receiving portion 120 are temporarily coupled together fall within the scope of the claims of the present invention.

Therefore, the conveying portion 110 and the receiving portion 120 are temporarily coupled together, because the demountable connecting posts 113 of the conveying portion 110 are temporarily coupled to the vias 123 of the receiving portion 120. Hence, the receiving portion 120 can be changed as needed. For instance, if the severed packs are large-sized, the receiving portion 120 must correspond in size to the severed packs so as to connect with the conveying portion 110.

In conclusion, the conveying portion 110 and the receiving portion 120 of the accelerated conveying device 100 are effective in speeding up the conveying of severed packs.

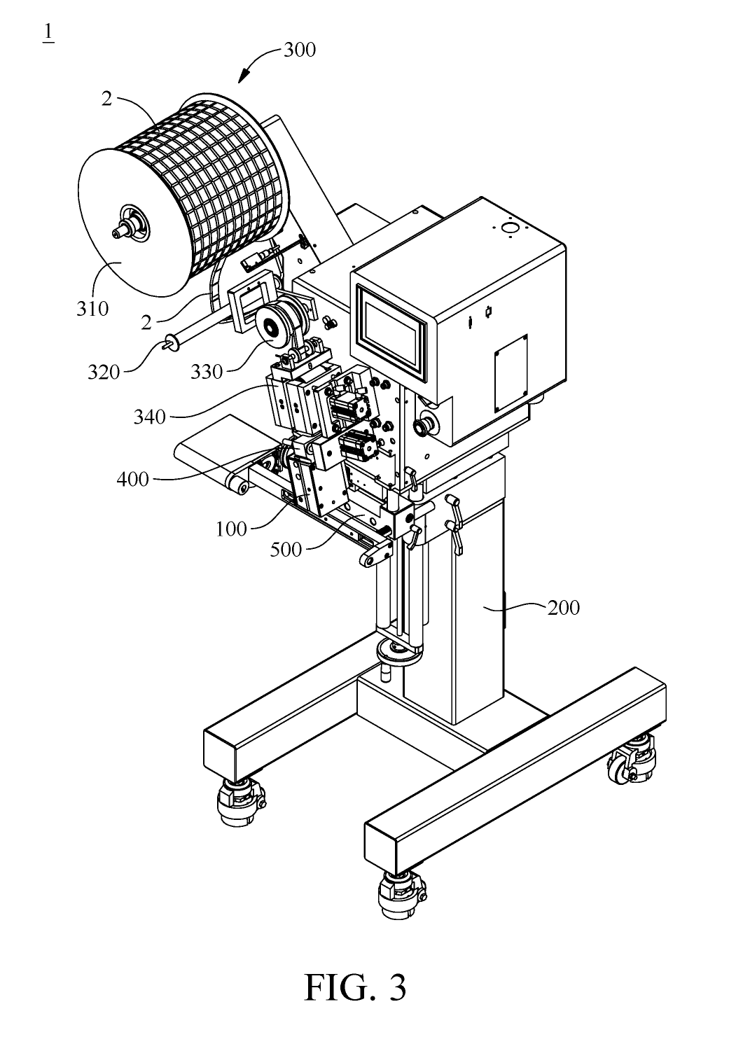

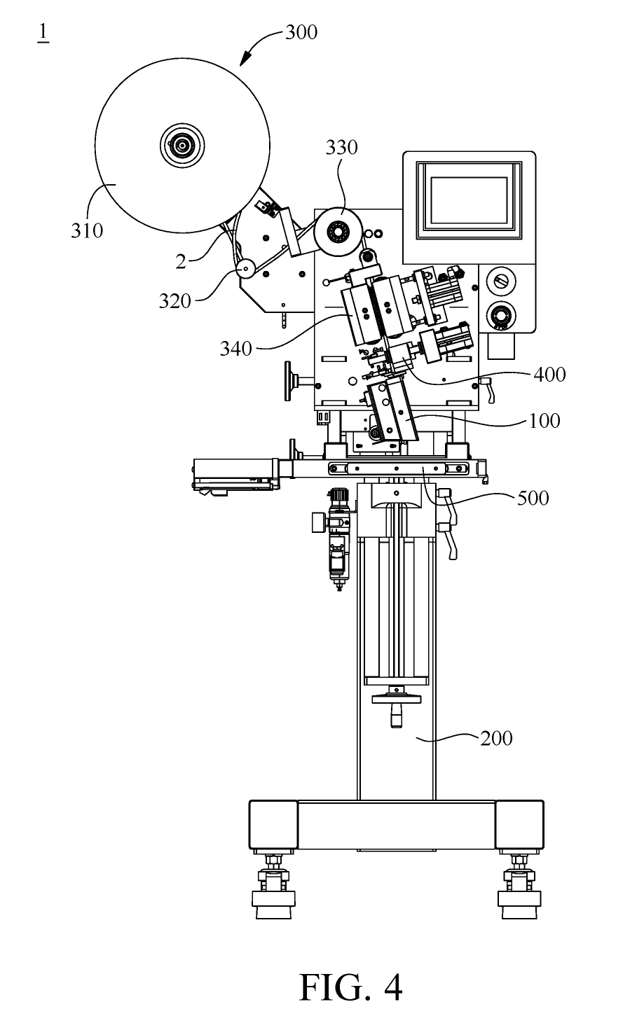

Referring to FIG. 3 and FIG. 4, there are shown a perspective view and a lateral view of a pack cutting machine 1 according to an embodiment of the present invention, respectively.

The pack cutting machine 1 comprises a machine body 200, a conveying system 300, a cutting device 400, and the accelerated conveying device 100.

The conveying system 300 is disposed on the machine body 200.

In this embodiment, the conveying system 300 is driven by a motor (not shown). The conveying system 300 includes a first conveying wheel 310, a swingarm device 320, a second conveying wheel 330, and a conveying continuous track unit 340.

The cutting device 400 is disposed on the machine body 200 and below the conveying system 300. The cutting device 400 has a blade (not shown).

The accelerated conveying device 100 is disposed on the machine body 200 and below the cutting device 400.

In practice, an unsevered pack 2 (such as a desiccant pack) is placed on a first conveying wheel 310, swingarm device 320, second conveying wheel 330, and conveying continuous track unit 340 of the conveying system 300, and then the unsevered pack 2 is conveyed by the first conveying wheel 310, swingarm device 320, second conveying wheel 330, and conveying continuous track unit 340 of the conveying system 300 sequentially. Afterward, as soon as the unsevered pack 2 passes through the cutting device 400, the unsevered pack 2 is severed to become a single pack (hereinafter referred to as a severed pack). Finally, the severed pack being conveyed is accelerated by the accelerated conveying device 100 before falling onto a collection table 500.

In conclusion, the accelerated conveying device 100 enhances the performance of the pack cutting machine 1 by speeding up the conveying of the severed packs.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. An accelerated conveying device for a pack cutting machine, adapted to convey a severed pack efficiently, comprising:
a conveying portion including a conveying body and an accelerated conveying element disposed at the conveying body; and
a receiving portion disconnectably connected to the conveying portion and including a receiving passage body and a through hole, with the through hole penetratingly disposed at a bottom surface of the receiving passage body and corresponding in position to the accelerated conveying element so as to be penetrable by the accelerated conveying element.

2. The accelerated conveying device for a pack cutting machine according to claim 1, wherein the conveying portion further comprises demountable connecting posts disposed at the conveying body.

3. The accelerated conveying device for a pack cutting machine according to claim 2, wherein the receiving portion further comprises vias which penetrate the receiving passage body and correspond in position to the demountable connecting posts, respectively.

4. The accelerated conveying device for a pack cutting machine according to claim 1, wherein the receiving passage body has a recess and a stopping element coveringly disposed at the recess.

5. The accelerated conveying device for a pack cutting machine according to claim 4, wherein the stopping element is transparent.

6. The accelerated conveying device for a pack cutting machine according to claim 1, wherein the accelerated conveying element is a conveying continuous track.

7. A pack cutting machine, comprising:
a machine body;
a conveying system disposed on the machine body;
a cutting device disposed on the machine body and below the conveying system; and
the accelerated conveying device of claim 1, disposed on the machine body and below the cutting device.

8. The pack cutting machine according to claim 7, wherein the conveying portion further comprises demountable connecting posts disposed at the conveying body.

9. The pack cutting machine according to claim 8, wherein the receiving portion further comprises vias which penetrate the receiving passage body and correspond in position to the demountable connecting posts, respectively.

10. The pack cutting machine according to claim 7, wherein the receiving passage body has a recess and a stopping element coveringly disposed at the recess.

11. The pack cutting machine according to claim 10, wherein the stopping element is transparent.

12. The pack cutting machine according to claim 7, wherein the accelerated conveying element is a conveying continuous track.

13. The pack cutting machine according to claim 7, wherein the accelerated conveying device is oblique to a horizontal plane of the machine body.
